(19) United States
(12) Patent Application Publication
(10) Pub. No.: US 2007/0080052 A1
(43) Pub. Date: Apr. 12, 2007

(54) Distillative merthod for separating narrow boiling or azeotropic mixtures using ionic liquids

(76) Inventors: York Alexander Beste, Mannheim (DE); Hartmut Schoenmakers, Dossenheim (DE)

Correspondence Address: CONNOLLY BOVE LODGE & HUTZ, LLP, P O BOX 2207, WILMINGTON, DE, 19899, US

(21) Appl. No.: 10/566,935

(22) PCT Filed: Jul. 15, 2004
(86) PCT No.: PCT/EP04/07869

§ 371 Date: Jul. 3, 2006

(30) Foreign Application Priority Data
Aug. 5, 2003 (DE) 10336556.7

(51) Int. Cl. B01D 3/34

(52) U.S. Cl. 203/50; 203/99; 203/98; 203/DIG. 19

(57) ABSTRACT

A process for separating azeotropic or close-boiling mixtures by means of an extractive rectification in which an ionic liquid is used as entrainer, wherein a high boiling bottom product is taken off from the column in vapor form via a side offtake.

The present invention relates to an improved process for separating azeotropic or close-boiling mixtures by means of an extractive rectification

Many liquid mixtures which cannot be separated by conventional rectification and are preferably separated by extractive rectification [Stichimair, S. and Fair, J., Distillation, ISBN 0-471-25241-7, page 241 ff] occur in industry. This is due to the similar boiling behavior of the components of the mixture, i.e. the fact that at a defined pressure and a defined temperature they are distributed in virtually the same or the same molar concentration ratio over the vapor phase and liquid phase.

In the case of a binary liquid mixture consisting of the components i and j, the difficulty of the separation task in rectification is indicated by the separation factor αᵢⱼ, viz. the ratio of the partition coefficients of the components i and j. The closer the separation factor is to one, the more costly the separation of the components of the mixture by means of conventional rectification, since either the number of theoretical plates in the rectification column and/or the reflux ratio at the top of the column has/have to be increased. If the separation factor is one, an azeotropic mixture is present and further concentration of the components of the mixture is no longer possible even when the number of theoretical plates or the reflux ratio is increased. In general, it has to be noted that the separation factor can be greater than or smaller than 1, depending on whether the partition coefficient of the low boiler is in the numerator or the denominator. Normally, the low boiler is entered in the numerator, so that the separation factor is greater than 1.

A procedure which is frequently practiced in industry for the separation of close-boiling systems, viz. systems having a separation factor of smaller than about 1.2, or azeotropic systems, is addition of a selective additive, known as an entrainer, in an extractive rectification. A suitable additive interacts selectively with one or more of the components of the mixture and thus influences the separation factor so that separation of the close-boiling or azeotropically boiling components of the mixture is made possible. In extractive rectification, the overhead and bottom components obtained by means of the action of the entrainer are the target components from the column. The overhead component is the component which has a lower boiling point in the presence of the entrainer, and the components which have a higher boiling point in the presence of the entrainer are present in the bottoms.

A measure of intensity of the interactions of the entrainer with one or more of the components of the mixture is the selectivity. The selectivity is defined as the ratio of the interfacial activity coefficient of the component i to the interfacial activity coefficient of the component j, with the components i and j being present in infinite dilution in the entrainer [Schult, C. J. et. al.; Infinite-dilution activity coefficients for several solutes in hexadecane and in n-methyl-2-pyrrolidone (NMP): experimental measurements and UNIFAC predictions; Fluid Phase Equilibria 179 (2001) pp. 117-129]. As indicated by Schult et. al., a higher entrainer selectivity leads to a higher relative volatility, a smaller reflux ratio and thus to lower separation costs. As disclosed below, a very high selectivity of, for example, greater than 1.3, preferably greater than 2.0, is desirable.

WO 02/074718 discloses that ionic liquids are particularly good entrainers for the separation of close-boiling or azeotropic liquid mixturer and are superior to conventional entrainers. The superiority can be seen directly in the selectivity and separation factor. When using a suitable ionic liquid, the separation factor at the azeotropic point is farther from one than when using a conventional additive in the same amount.

For the purposes of the present invention, ionic liquids are as defined by Wasserscheid and Keim in Angewandte Chemie 2000, 112, 3926-3945. The class of ionic liquids represents a new type of solvent. As indicated in the publication mentioned, ionic liquids are salts which melt at relatively low temperatures and have a nonmolecular, ionic character. They are liquid at relatively low temperatures of less than 200° C., preferably less than 150° C., particularly preferably less than 100° C. and have a relatively low viscosity. They have very good solvent capabilities for a large number of organic, inorganic and polymeric substances.

Compared to ionic salts, ionic liquids are liquid at significantly lower temperatures (in general below 200° C.) and frequently have a melting point below 0° C., in one case down to −96° C., which is important for the industrial implementation of extractive rectification.

In addition, ionic liquids are generally nonflammable, noncorrosive and have a low viscosity and also display an imperceptible vapor pressure.

For the purposes of the present invention, ionic liquids are compounds which have at least one positive charge and at least one negative charge but are overall electrically neutral and have a melting point below 200° C., preferably below 100° C., particularly preferably below 50° C.

The ionic liquids can also have a plurality of positive or negative charges, for example from 1 to 5, preferably from 1 to 4, particularly preferably from 1 to 3, very particularly preferably 1 or 2, but in particular one positive charge and one negative charge.

The charges can be located in various localized or delocalized regions within a molecule, i.e. in a betaine-like fashion, or be distributed over separate anionis and cations. Preference is given to ionic liquids which are made up of at least one cation and at least one anion. Cation and anion can, as indicated above, bear one or more charges, preferably a single charge.

Of course, mixtures of various ionic liquids or mixtures of conventional entrainers such as N-methylpyrrolidone, dimethylformamide, ethanediol, benzene, cyclohexane, water, etc., with ionic liquids are also conceivable.

Preferred cations are ammonium or phosphonium ions or cations containing at least one five- or six-membered heterocycle which has at least one phosphorus or nitrogen atom and, if desired, an oxygen or sulfur atom, particularly preferably compounds which contain at least one five- or six-membered heterocycle having one, two or three nitrogen atoms and one sulfur or oxygen atom, very particularly preferably compounds having one or two nitrogen atoms.

Particularly preferred ionic liquids are those having a molecular weight of less than 1000 g/mol, very particularly preferably less than 350 g/mol.

Furthermore, preference is given to cations selected from among the compounds of the formulae (Ia) to (Iw), 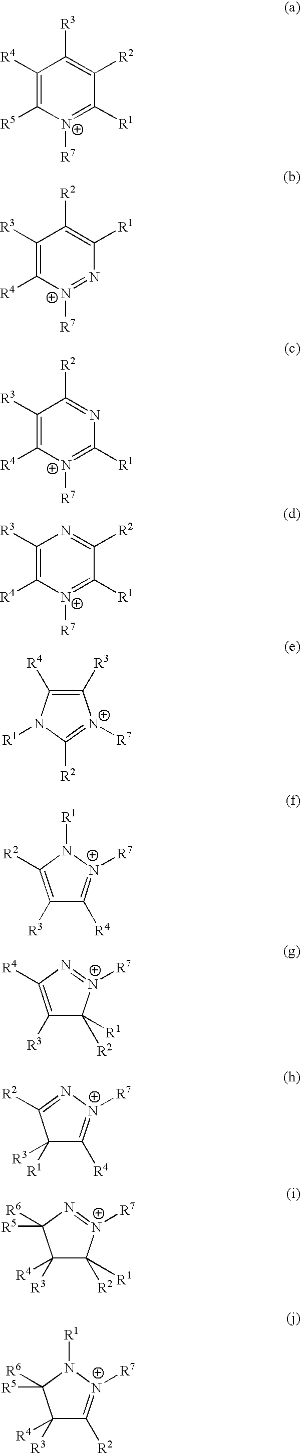 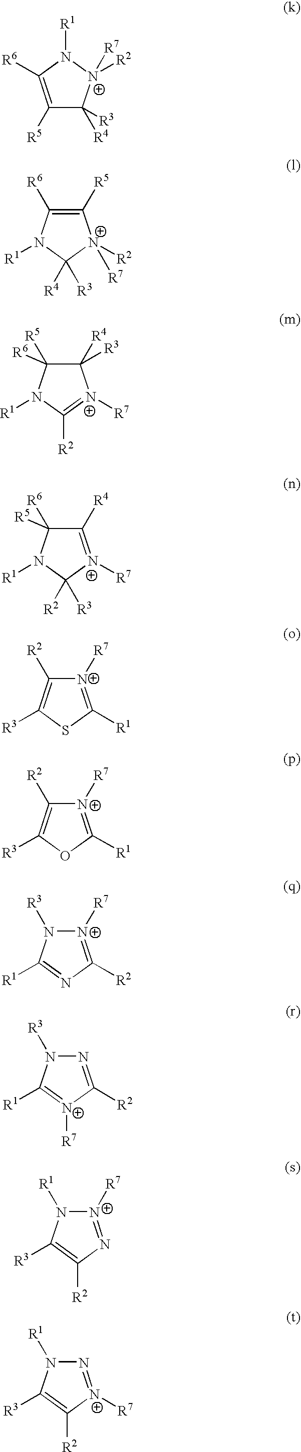 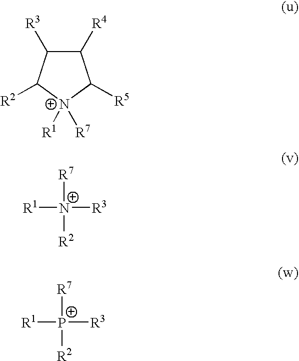
and also oligomers and polymers comprising these structures,

where

R¹, R², R³, R⁴, R⁵, R⁶ and R⁷ are each, independently of one another, C₁-C₁₈-alkyl, C₂-C₁₈-alkyl which may be interrupted by one or more oxygen and/or sulfur atoms and/or one or more substituted or unsubstituted imino groups, C₆-C₁₂-aryl, C₅-C₁₂-cycloalkyl or a five- or six-membered, oxygen-, nitrogen- and/or sulfur-containing heterocycle or two of them together form an unsaturated, saturated or aromatic ring which may be interrupted by one or more oxygen and/or sulfur atoms and/or one or more substituted or unsubstituted imino groups, where the radicals mentioned may each be substituted by functional groups, aryl, alkyl, aryloxy, alkyloxy, halogen, heteroatoms and/or heterocycles.

In addition, R¹, R², R³, R⁴, R⁵ and R⁶ can also be hydrogen.

R⁷ can also be C₁-C₁₈-alkyloyl (alkylcarbonyl), C₁-C₁₈-alkyloxycarbonyl, C₅-C₁₂-cycloalkylcarbonyl or C₆-C₁₂-aryloyl (arylcarbonyl), where the radicals mentioned may each be substituted by functional groups, aryl, alkyl, aryloxy, alkyloxy, halogen, heteroatoms and/or heterocycles.

In these formulae,

C₁-C₁₈-alkyl which may be substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl,1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl, and

C₂-C₁₈-alkyl which may be interrupted by one or more oxygen and/or sulfur atoms and/or one or more substituted or unsubstituted imino groups is, for example, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, these radicals together can be 1,3-propylene, 1,4-butylene, 2-oxa-1,3-propylene, 1-oxa-1,3-propylene, 2-oxa-1,3-propylene, 1-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of oxygen and/or sulfur atoms and/or imino groups is not subject to any restrictions. In general, there are not more than 5 such atoms or groups in the radical, preferably not more than 4 and very particularly preferably not more than 3.

Furthermore, there is generally at least one carbon atom, preferably at least two carbon atoms, between any two heteroatoms.

Substituted and unsubstituted imino groups can be, for example, imino, methylimino, isopropylimino, n-butylimino or tert-butylimino.

Furthermore,

functional groups are carboxyl, carboxamide, hydroxyl, di(C₁-C₄-alkyl)amino, C₁-C₄-alkyloxycarbonyl, cyano or C₁-C₄-alkyloxy,

C₆-C₁₂-aryl which may be substituted by functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-diethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxyethylphenyl,

C₅-C₁₂-cycloalkyl which may be substituted by functional groups, aryl, alkyl, aryloxy, alkyloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl,

a five- or six-membered, oxygen-, nitrogen- and/or sulfur-containing heterocycle is, for example, furyl, thiophenyl, pyrryl, pyridyl, indolyl, benzoxazolyl, dioxolyl, dioxyl, benzimidazolyl, benzothiazolyl, dimethylpyridyl, methylquinolyl, dimethylpyrryl, methoxyfuryl, dimethoxypyridyl, difluoropyridyl, methylthienyl, isopropylthienyl or tert-butylthienyl and

C₁-C₄-alkyl is, for example, methyl, ethyl, propyl, isopropyl, n-butyl, sec-butyl or tert-butyl.

C₁-C₁₈-Alkyloyl (alkylcarbonyl) can be, for example, acetyl, propionyl, n-butyloyl, sec-butyloyl, tert-butyloyl, 2-ethylhexylcarbonyl, decanoyl, dodecanoyl, chloroacetyl, trichloroacetyl or trifluoroacetyl.

C₁-C₁₈-Alkyloxycarbonyl can be, for example, methyloxycarbonyl, ethyloxycarbonyl, propyloxycarbonyl, isopropyloxycarbonyl, n-butyloxycarbonyl, sec-butyloxycarbonyl, tert-butyloxycarbonyl, hexyloxycarbonyl, 2-ethylhexyloxycarbonyl or benzyloxycarbonyl.

C₅-C₁₂-Cycloalkylcarbonyl can be, for example, cyclopentylcarbonyl, cyclohexylcarbonyl or cyclododecylcarbonyl.

C₆-C₁₂-Aryloyl (arylcarbonyl) can be, for example, benzoyl, toluyl, xyloyl, α-naphthoyl, β-naphthoyl, chlorobenzoyl, dichlorobenzoyl, trichlorobenzoyl or trimethylbenzoyl.

Preference is given to R¹, R², R³, R⁴, R⁵ and R⁶ each being, independently of one another, hydrogen, methyl, ethyl, n-butyl, 2-hydroxyethyl, 2-cyanoethyl, 2-(methoxycarbonyl)ethyl, 2-(ethoxycarbonyl)ethyl, 2-(n-butoxycarbonyl)ethyl, dimethylamino, diethylamino or chlorine.

R⁷ is preferably methyl, ethyl, n-butyl, 2-hydroxyethyl, 2-cyanoethyl, 2-(methoxycarbonyl)ethyl, 2-(ethoxycarbonyl)ethyl, 2-(n-butoxycarbonyl)ethyl, acetyl, propionyl, t-butyryl, methoxycarbonyl, ethoxycarbonyl or n-butoxycarbonyl.

Particularly preferred pyridinium ions (Ia) are those in which one of the radicals R¹ to R⁵ is methyl, ethyl or chlorine, R⁷ is acetyl, methyl, ethyl or n-butyl and all others are hydrogen, or R³ is dimethylamino, R⁷ is acetyl, methyl, ethyl or n-butyl and all others are hydrogen or R⁷ is acetyl, methyl, ethyl or n-butyl and all others are hydrogen or R² is carboxyl or carboxamide, R⁷ is acetyl, methyl, ethyl or n-butyl and all others are hydrogen or R¹ and R² or R² and R³ together form 1,4-buta-1,3-dienylene, R⁷ is acetyl, methyl, ethyl or n-butyl and all others are hydrogen.

Particularly preferred pyridazinium ions (Ib) are those in which one of the radicals R¹ to R⁴ is methyl or ethyl, R⁷ is acetyl, methyl, ethyl or n-butyl and all others are hydrogen or R⁷ is acetyl, methyl, ethyl or n-butyl and all others are hydrogen.

Particularly preferred pyrimidinium ions (Ic) are those in which R² to R⁴ are each hydrogen or methyl, R⁷ is acetyl, methyl, ethyl or n-butyl and R¹ is hydrogen, methyl or ethyl, or R² and R⁴ are each methyl, R³ is hydrogen and R¹ is hydrogen, methyl or ethyl and R⁷ is acetyl, methyl, ethyl or n-butyl.

Particularly preferred pyrazinium ions (Id) are those in which

R¹ to R⁴ are all methyl and

R⁷ is acetyl, methyl, ethyl or n-butyl or R⁷ is acetyl, methyl, ethyl or n-butyl and all others are hydrogen.

Particularly preferred imidazolium ions (Ie) are those in which, independently of one another,

R¹ is selected from among methyl, ethyl, n-propyl, n-butyl, n-pentyl, n-octyl, n-decyl, n-dodecyl, 2-hydroxyethyl and 2-cyanoethyl,

R⁷ is acetyl, methyl, ethyl or n-butyl and

R²to R⁴ are each, independently of one another, hydrogen, methyl or ethyl.

Particularly preferred 1 H-pyrazolium ions (If) are those in which, independently of one another

R¹ is selected from among hydrogen, methyl and ethyl,

R², R³ and R⁴ are selected from among hydrogen and methyl and

R⁷ is selected from among acetyl, methyl, ethyl and n-butyl.

Particularly preferred 3H-pyrazolium ions (Ig) are those in which, independently of one another,

R¹ is selected from among hydrogen, methyl and ethyl,

R², R³ and R⁴ are selected from among hydrogen and methyl and

R⁷ is selected from among acetyl, methyl, ethyl and n-butyl.

Particularly preferred 4H-pyrazolium ions (Ih) are those in which, independently of one another,

R¹ to R⁴ are selected from among hydrogen and methyl and

R⁷ is selected from among acetyl, methyl, ethyl and n-butyl.

Particularly preferred 1-pyrazolinium ions (Ii) are those in which, independently of one another,

R¹ to R⁶ are selected from among hydrogen and methyl and

R⁷ is selected from among acetyl, methyl, ethyl and n-butyl.

Particularly preferred 2-pyrazolinium ions (Ij) are those in which, independently of one another,

R¹ is selected from among hydrogen, methyl, ethyl and phenyl,

R⁷ is selected from among acetyl, methyl, ethyl and n-butyl and

R² to R⁶ are selected from among hydrogen and methyl.

Particularly preferred 3-pyrazolinium ions (Ik) are those in which, independently of one another,

R¹ and R² are selected from among hydrogen, methyl, ethyl and phenyl,

R⁷ is selected from among acetyl, methyl, ethyl and n-butyl and

R³ to R⁶ are selected from among hydrogen and methyl.

Particularly preferred imidazolinium ions (II) are those in which, independently of one another,

R¹ and R² are selected from among hydrogen, methyl, ethyl, n-butyl and phenyl,

R⁷ is selected from among acetyl, methyl, ethyl and n-butyl and

R³ and R⁴ are selected from among hydrogen, methyl and ethyl and

R⁵ and R⁶ are selected from among hydrogen and methyl.

Particularly preferred imidazolinium ions (Im) are those in which, independently of one another,

R¹ and R² are selected from among hydrogen, methyl and ethyl,

R⁷ is selected from among acetyl, methyl, ethyl and n-butyl and

R³ to R⁶ are selected from among hydrogen and methyl.

Particularly preferred imidazolinium ions (In) are those in which, independently of one another,

R¹, R² and R³ are selected from among hydrogen, methyl and ethyl,

R⁷ is selected from among acetyl, methyl, ethyl and n-butyl and

R⁴ to R⁶ are selected from among hydrogen and methyl.

Particularly preferred thiazolium ions (Io) and oxazolium ions (Ip) are those in which, independently of one another,

R¹ is selected from among hydrogen, methyl, ethyl and phenyl,

R⁷ is selected from among acetyl, methyl, ethyl and n-butyl and

R² and R³ are selected from among hydrogen and methyl.

Particularly preferred 1,2,4-triazolium ions (Iq) and (Ir) are those in which, independently of one another,

R¹ and R² are selected from among hydrogen, methyl, ethyl and phenyl,

R⁷ is selected from among acetyl, methyl, ethyl and n-butyl and

R³ is selected from among hydrogen, methyl and phenyl.

Particularly preferred 1,2,3-triazolium ions (Is) and (It) are those in which, independently of one another,

R¹ is selected from among hydrogen, methyl and ethyl,

R⁷ is selected from among acetyl, methyl, ethyl and n-butyl and

R² and R³ are selected from among hydrogen and methyl or

R² and R³ together form a 1,4-buta-1,3-dienylene group and all others are hydrogen.

Particularly preferred pyrrolidinium ions (Iu) are those in which, independently of one another,

R¹ and R⁷ are selected from among acetyl, methyl, ethyl and n-butyl and

R², R³, R⁴ and R⁵ are each hydrogen.

Particularly preferred ammonium ions (Iv) are those in which, independently of one another,

R⁷ is selected from among acetyl, methyl, ethyl and n-butyl and

R¹, R² and R³ are selected from among methyl, ethyl, n-butyl, 2-hydroxyethyl, benzyl and phenyl.

Particularly preferred phosphonium ions (Iw) are those in which, independently of one another,

R⁷ is selected from among acetyl, methyl, ethyl and n-butyl and

R¹, R² and R³ are selected from among phenyl, phenoxy, ethoxy and n-butoxy.

Among these, preference is given to the ammonium, phosphonium, pyridinium and imidazolium ions.

Very particularly preferred cations are 1,2-dimethylpyridinium, 1-methyl-2-ethylpyridinium, 1-methyl-2-ethyl-6-methylpyridinium, N-methylpyridinium, 1-butyl-2-methylpyridinium, 1-butyl-2-ethylpyridinium, 1-butyl-2-ethyl-6-methylpyridinium, N-butylpyridinium, 1-butyl-4-methylpyridinium, 1,3-dimethylimidazolium, 1,2,3-trimethylimidazolium, 1-n-butyl-3-methylimidazolium, 1,3,4,5-tetramethylimidazolium, 1,3,4-trimethylimidazolium, 2,3-dimethylimidazolium, 1-butyl-2,3-dimethylimidazolium, 3,4-dimethylimidazolium, 2-ethyl-3,4-dimethylimidazolium, 3-methyl-2-ethylimidazolium, 3-butyl-1-methylimidazolium, 3-butyl-1-ethylimidazolium, 3-butyl-1,2-dimethylimidazolium, 1,3-di-n-butylimidazolium, 3-butyl-1,4,5-trimethylimidazolium, 3-butyl-1,4-dimethylimidazolium, 3-butyl-2-methylimidazolium, 1,3-dibutyl-2-methylimidazolium, 3-butyl-4-methylimidazolium, 3-butyl-2-ethyl-4-methylimidazolium und 3-butyl-2-ethylimidazolium, 1-methyl-3-octylimidazolium, 1-decyl-3-methylimidazolium.

Especial preference is given to 1-butyl-4-methylpyridinium, 1-n-butyl-3-methylimidazolium and 1-n-butyl-3-ethylimidazolium.

As anions, all anions are conceivable in principle.

Preferred anions are halides, F⁻, Cl⁻, Br⁻, I⁻, acetate CH₃COO⁻, trifluoroacetate CF₃COO⁻, triflate CF₃SO₃⁻, sulfate SO₄²⁻, hydrogensulfate HSO₄⁻, methylsulfate CH₃OSO₃⁻, ethylsulfate C₂H₅OSO₃⁻, sulfite SO₃²⁻, hydrogensulfite HSO₃⁻, chloroaluminates AlCl₄⁻, Al₂Cl₇⁻, Al₃Cl₁₀⁻, tetrabromoaluminate AlBr₄⁻, nitrite NO₂⁻, nitrate NO₃⁻, chlorocuprate CuCl₂⁻, phosphate PO₄³⁻, hydrogenphosphate HPO₄²⁻, dihydrogenphosphate H₂PO₄⁻, carbonate CO₃²⁻, hydrogencarbonate HCO₃⁻.

Particular preference is given to acetates, sulfonates, tosylate p-CH₃C₆H₄SO₃⁻, sulfates, phosphates, bis(trifluoromethylsulfonyl)imide (CF₃SO₂)₂N⁻.

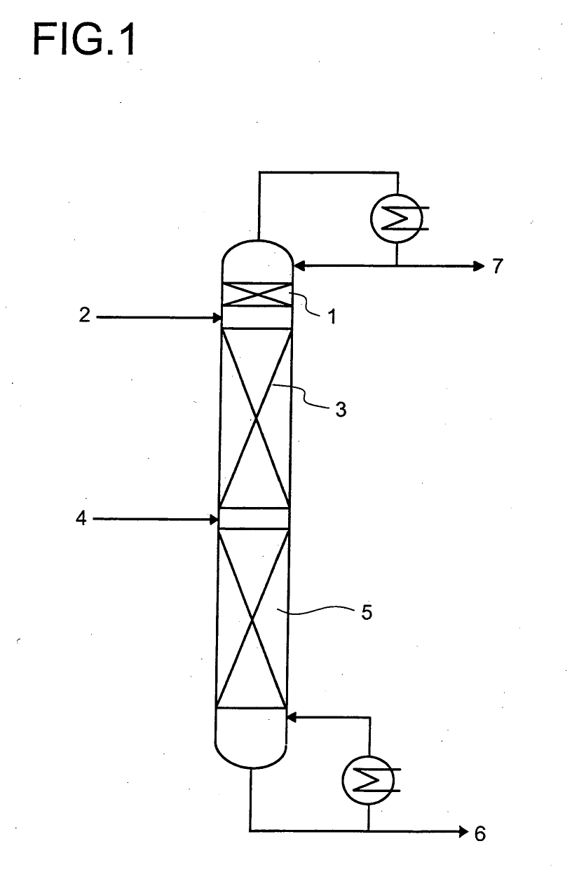

An embodiment of extractive rectification is described in WO 02/074718 (cf. FIG. 1). (2) indicates the inflow of the entrainer into a countercurrent rectification column. Since in conventional processes the entrainer has a low but appreciable volatility compared to the overhead product (stream 7), the separation elements (1) have to be used to separate overhead product and entrainer. The separation elements (3) and (5) effect the desired separation of overhead product from bottom product under the action of the entrainer, stream (4) is the feed stream of the components to be separated (feed), stream (6) is the bottom product and the entrainer. Separation elements can be, for example, trays, ordered packing or random packing.

The use of an ionic liquid as entrainer has the advantage that the vapor pressure of the pure ionic liquid and thus also its partial pressure in the mixture with the overhead product are close to zero. Thus, the separation elements (1) can be dispensed with. Only when volatile impurities are present in the ionic liquid, e.g. components which have not been able to be separated off completely during recycling, is this not the case. To separate these impurities from the overhead product, it may be necessary to install an enrichment section between the feed point for the ionic liquid and the top of the columns.

The known advantages of ionic liquids compared to conventional entrainers in extractive rectification are essentially:
Ionic liquids are more selective than conventional entrainers. Due to their comparatively high selectivity, they make it possible for a smaller mass flow, compared to conventional extractive rectification, of entrainer to be fed to the extractive rectification and/or the number of theoretical plates in the extractive rectification column to be reduced.
As a result of the extremely low vapor pressure of the entrainer, various separation operations which offer operating and capital cost advantages over the second rectification column in conventional extractive rectification can be used for separating the entrainer from the bottom product.
The separation elements (1) lead to separation of the entrainer from the overhead product in conventional extractive rectification, but the separation is never complete. Discharge of proportions of ionic liquid via the vapor phase without the separation elements (1) is not possible because of the extremely low volatility of the ionic liquid.
Capital costs are reduced by elimination of the separation elements (1).

Suitable ionic liquids are ones which in a total concentration in the liquid of from 5 to 90 mol %, preferably from 10 to 70 mol %, lead to a separation factor between the target components which is different from one.

The use of ionic liquids as entrainers in extractive rectification is particularly useful, inter alia, for the following applications: for example azeotropes: amines/water, THF/water, formic acid/water, alcohols/water, acetone/methanol, acetates/water, acrylates/water, trimethyl borate/methanol, or close-boiling mixtures: acetic acid/water, C4-hydrocarbons, C3-hydrocarbons, alkanes/alkenes, general separation of polar and nonpolar materials which form azeotropes or are close-boiling.

However, the recovery of the ionic liquid after the extractive distillation has hitherto not been solved satisfactorily. Conventional entrainers are usually separated off from the bottom product in a second distillation column. Since ionic liquids cannot be vaporized, accumulation in a countercurrent distillation process is not advantageous and leads to unnecessary capital costs.

WO 02/07418 gives general information as to how the entrainer present can be recovered (page 16). Apart from vaporization, the use of a stripping column or precipitation into a solid phase are also mentioned.

The German patent application number 10313207.4 describes adsorptive separation processes by means of which high boilers which are no longer vaporizable are said to be able to be separated off from an ionic liquid. Such a situation occurs when the vaporizable components have already been separated off from the ionic liquid. The mixtures in question are usually mixtures having a very high proportion of ionic liquid and a low level of impurities which would nevertheless accumulate if they were not separated off. Purge streams from IF-containing recycle streams are, for example, a main application here.

In the separation of the mixture, it is generally desirable to obtain both the low boiler and the high boiler in highly pure form in a technically simple manner. Furthermore, separating the valuable ionic liquid from high boilers still present after the extractive rectification and recovering it in high purity are complicated in process engineering terms and are energy-consuming. In this context, high boilers are all vaporizable products which are not taken off as desired low boilers at the top of the extractive distillation column. In the system tetrahydrofuran (THF)/water, for example, the THF would be the low boiler and the water would be the high boiler. Particularly when there is a relatively large proportion of high boiler in the bottom stream from the column, further separation can be extremely difficult.

It is an object of the present invention to find an improved process for separating azeotropic or close-boiling mixtures by means of an extractive rectification, which remedies the abovementioned disadvantages and allows separation to be achieved in a technically simple and economical manner.

We have found that this object is achieved by a process for separating azeotropic or close-boiling mixtures by means of an extractive rectification in which an ionic liquid is used as entrainer, wherein a high-boiling bottom product is taken off from the column in vapor form via a side offtake.

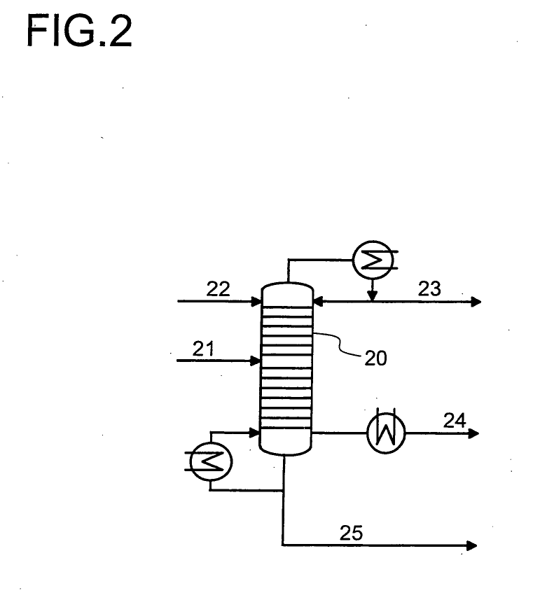

The process of the present invention is shown by way of example in FIG. 2.

The countercurrent rectification column (20) is supplied with the feed via line (21) and with the ionic liquid as entrainer via line (22). The overhead stream is taken off via line (23).

In the stripping section of the extractive rectification column, the low boiler(s) (LB) is separated off from the high boiler(s) (HB) and the ionic liquid (IL), so that no low boiler is present in the bottoms. This can be achieved by a person skilled in the art of distillation by means of a sufficient number of theoretical plates in the stripping section when the IL gives a selectivity of greater than 1.3, which is its nominated task. Since the IL has no vapor pressure, the vapor phase at the bottom consists entirely of high boilers. This is taken off as a gaseous side stream (24). This side offtake and the equipment necessary are designed according to the usual rules of distillation, depending on the specific separation task in question. Since the separation factor between IL and HB is infinite, one vaporization stage is sufficient for separation. If other high-boiling impurities are present or are formed in the liquid phase or a mixture of IL and conventional solvents has been used as entrainer, further separation elements are necessary.

The high-boiling product is preferably taken off in the side stream in the stripping section close to the bottom, particularly preferably from one of the three bottommost plates, very particularly preferably directly from the bottommost plate.

The optimum amount of the side stream depends on the permissible temperature at the bottom of the extractive rectification column. The larger the stream, the more HB is removed from the stripping section of the column and the less HB is present in the IL and thus in the bottoms. As a consequence, the temperature increases at the bottom since the IL has no vapor pressure. Here, the thermal stability of the components in the bottoms and the stressability of the material have to be taken into account. The object is a very low HB content in the IL without thermal damage occurring. Depending on the mixture and the operating pressure, the permissible temperature at the bottom can be from 50° C. to above 200° C. It is preferably in the range from 100 to 200° C. Owing to the thermal stability of customary ionic liquids, a temperature of 250° C., preferably 200° C., should not be exceeded.

The side stream enables the HB content of the IL to be reduced greatly. It is possible to achieve HB contents in the IL of less than 10%, preferably less than 5%, particularly preferably less than 1%, with the achievable values depending on the pressure and permissible temperature in the bottom of the column. The removal of the HB from the IL is aided not only by a high temperature but also a high vapor pressure of the HB and a low column pressure. The concentrations indicated are, unless indicated otherwise, by mass, i.e. % means % by weight and ppm means ppm by weight.

If the HB is to be obtained as liquid product, the gaseous side stream has to be liquefied by means of an additional condenser.

The bottom stream is discharged from the column (20) via the line (25). In downstream process steps such as vaporization and/or stripping, further high boiler still present in this mixture can be separated off.

The process of the present invention makes it possible to reduce the high boiler content of the bottom stream obtained from the column. This reduction in concentration can in some applications meet the quality requirements for the ionic liquid so that the bottom stream obtained can be recirculated directly to a point close to the top of the column in order to reuse the ionic liquid as entrainer.

For economic reasons, the IL has to be circulated, i.e. HB remaining in the IL is returned together with the IL to the top of the extractive rectification column. There, part of the HB goes into the vapor phase and contaminates the top product (LB). If the purity requirements for the LB are moderate, then the reduction in concentration of the HB in the IL solely via the gaseous side stream is sufficient and no further work-up of the IL is necessary. In this particularly advantageous variant, an azeotropic or close-boiling mixture can be separated into low and high boilers by addition of an IL in a column without additional apparatus. Compared to a normal extractive rectification, which always requires a second column for the work-up of the entrainer, this represents an appreciable simplification of the process and gives considerable capital cost savings.

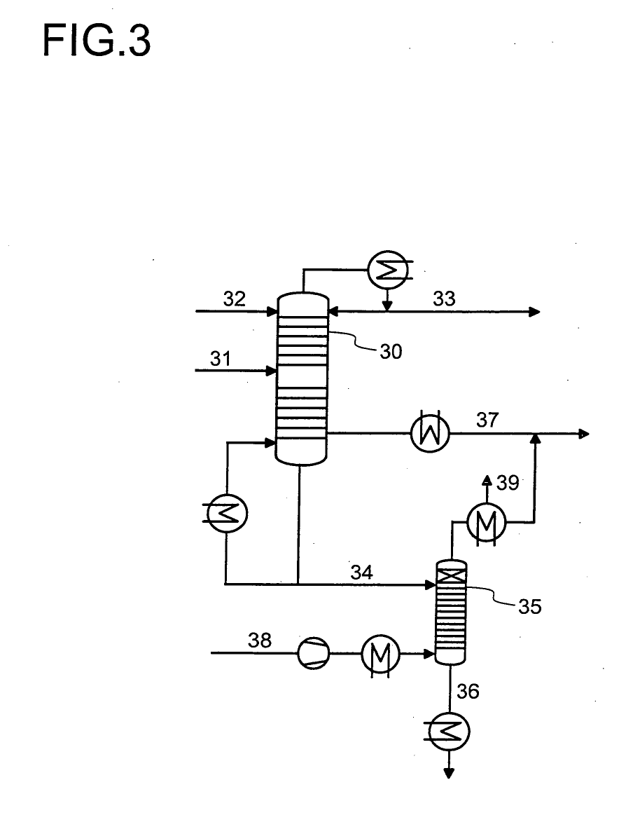

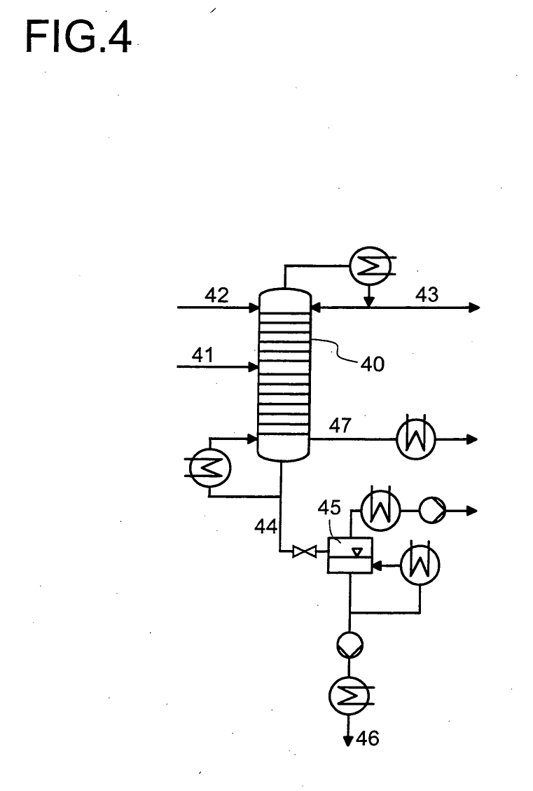

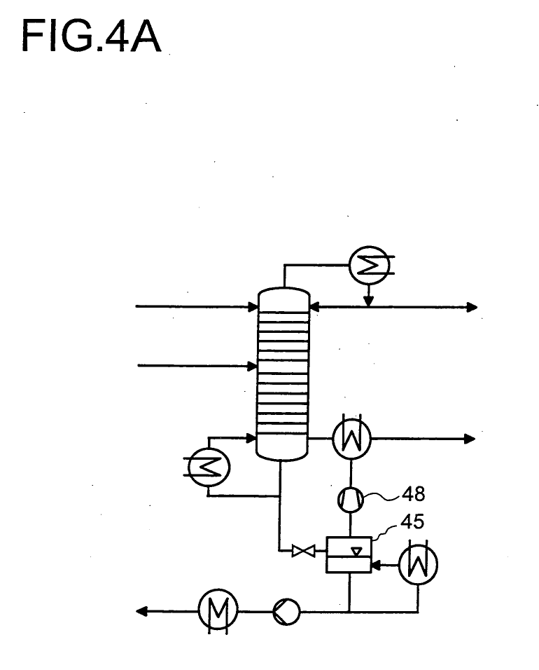

In the case of higher purity requirements or a not yet satisfactory decrease in concentration of high boilers in the bottom stream, it can be advisable to subject the stream to a further work-up before it is recirculated to the column in order to counter undesirable contamination of the overhead product. For this purpose, the bottom stream which has been taken off is fed to an evaporator and/or a stripping column in which the residual content of high boilers is reduced further. The ionic liquid obtained in this way is subsequently fed back into the column. These variants are shown by way of example in FIGS. 3 and 4. They correspond essentially to FIG. 2, but an additional work-up of the bottom stream is shown in these cases. This work-up is effected by means of a stripper (35) in FIG. 3 or by means of an evaporator (45) in FIGS. 4 and 4a. In FIG. 4a, the gas stream from the evaporator (45) is passed to a compressor (48).

The process of the present invention offers an economical and technically simple way of separating azeotropic or close-boiling mixtures. In this process, a large part of the high boiler present can be obtained in high purity with a low outlay in terms of apparatus. Depending on the particular, substance-specific boundary conditions and requirements, the ionic liquid obtained in the bottom stream can be recirculated directly to the column. In the case of increased purity requirements, a further separation by means of a work-up stage is necessary before recirculation, but the process engineering outlay required for this purpose is significantly lower because of the removal of the high boiler according to the present invention.

### EXAMPLES

In the following examples, all concentrations are, unless indicated otherwise, by mass, i.e. % is % by weight and ppm is ppm by weight.

In all examples, the feed to the extractive rectification column was 844 kg/h of a binary mixture consisting of 77% of TMB (trimethyl borate) and 23% of methanol. This is the azeotropic composition. The column always had 20 theoretical plates and was operated at a reflux ratio of RR=0.5 and a pressure of P=1 bar. The feed plate was always at theoretical plate 12.

### Example 1

### Extractive Rectification with Side Stream

(cf. FIG. 2)

1364 kg/h of the IL (1-ethyl-3-methylimidazolium tosylate) were introduced at the top of the column. The IL contained 1% of methanol. 657 kg/h of overhead product consisting of 99% of TMB and 1% of methanol were obtained. From the bottom region of the column, 179 kg/h of pure methanol were taken off in vapor form via a side offtake. Top and bottom temperatures established were 63 and 180° C., respectively. 1364 kg/h of a stream consisting of 99% of IL and 1% of methanol were obtained as bottom product.

The heat exchangers had the following power requirements: column condenser: 95 kW, column vaporizer: 303 kW, side stream condenser: 63 kW.

Result: The azeotrope is broken by the ionic liquid. A purity of 99% is achieved in the overhead product. If this product purity is sufficient, no further work-up of the IL discharged at the bottom is necessary. It can be recirculated directly to the top of the column. In this way, the use of IL as entrainer and a column with a side offtake can overcome the problem of the azeotrope and a product of relatively high purity can be produced.

### Example 2

### Extractive Rectification without Side Stream

1452 kg/h of the IL (1-ethyl-3-methylimidazolium tosylate) were introduced at the top of the column. The IL contained 1% of methanol. 657 kg/h of overhead product consisting of 99% of TMB and 1% of methanol were obtained. No side stream was taken off. Top and bottom temperatures established were 63 and 94° C., respectively. 1639 kg/h of a stream consisting of 87.6% of IL and 12.4% of methanol were obtained as bottom product. The heat exchangers had the following power requirements: column condenser: 95 kW, column vaporizer: 136 kW

Result: The IL-rich stream obtained at the bottom of the column has a methanol concentration of over 12%, which is too high. This IL cannot be circulated directly and returned to the column, since purities of 99% in the distillate would then not be possible.

1. A process for separating azeotropic or close-boiling mixtures by means of an extractive rectification in which an ionic liquid is used as entrainer, wherein a high-boiling bottom product is taken off from the column in vapor form via a side offtake.

2. A process as claimed in claim 1, wherein the side offitake is positioned in the stripping section of the column in the region of the bottommost three plates, preferably directly at the bottommost plate.

3. A process as claimed in claim 1, wherein the bottom stream from the column is passed to a work-up stage in which the ionic liquid present is separated off from high boilers still present by vaporization.

4. A process as claimed in claim 1, wherein the bottom stream from the column is passed to a work-up stage in which the ionic liquid present is separated off from high boilers still present by stripping.

5. A process as claimed in claim 1, wherein the bottom stream which has been depleted in high boilers is recirculated to the column, preferably in the enrichment section, particularly preferably onto one of the uppermost 3 plates, very particularly preferably onto the uppermost plate.

6. A process as claimed in claim 3, wherein the ionic liquid recovered from the work-up stage is recirculated to the column, preferably in the enrichment section, particularly preferably onto one of the uppermost 3 plates, very particularly preferably onto the uppermost plate.
